(19) United States
(12) Patent Application Publication
(10) Pub. No.: US 2007/0102035 A1
(43) Pub. Date: May 10, 2007

(54) Method and Structure for Integrated Solar Cell LCD Panel

(75) Inventor: Xiao (Charles) Yang, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Xiai (Charles) Yang, Cupertino, CA (US)

(21) Appl. No.: 11/554,496

(22) Filed: Oct. 30, 2006

Related U.S. Application Data
(60) Provisional application No. 60/732,388, filed on Oct. 31, 2005.

(51) Int. Cl. H02N 6/00

(52) U.S. Cl. 136/244

(57) ABSTRACT

The present invention relates to a method and device for integrating solar cell on LCD panels for photovoltaic electricity generation for portable electronic devices. According to one embodiment of the present invention, the black matrix region on the color filter substrate in a LCD panel is replaced by a solar cell region. A lens array substrate is coupled between the light source layer and the TFT to focus the backlight to increase the solar cell layer area while maintaining high fill ratio of the LCD pixels. The solar cell material is selected from at least silicon, a single crystal silicon, poly-crystalline silicon, amorphous silicon, gallium arsenide, cadmium telluride, copper indium diselenide, organic/inorganic, or hybrid cells. The substrate material is selected from glass, metal, plastic or polymer.

This application claims priority to provisional application Ser. No. 60/732,388; filed on Oct. 31, 2006; commonly assigned, and of which is hereby incorporated by reference for all purposes.

### BACKGROUND OF THE INVENTION

Portable electronics devices such as cell phones become indispensable part of daily life. As more features such as music and video added to cell phones, power consumption increases significantly. Battery life becomes a bottleneck. Furthermore, dead batteries in cell phones cause inconvenience and have safety concerns in an emergency situation. Commercially available stand-alone solar panel for charging portable electronic devices is bulky and cumbersome; therefore it has not been adopted widely by consumers. Thus, there is a need in the art for methods and apparatus for fabricating an integrate solar cell devices on LCD panel for photovoltaic electricity generation for portable electronic devices.

### SUMMARY OF THE INVENTION

According to the present invention, techniques for manufacturing objects are provided. More particularly, the invention provides a method and device for integrating solar cell on LCD panels for photovoltaic electricity generation for portable electronic devices.

A typical LCD panel is consisted with a front polarizer, a color filter, Liquid Crystal layer, a TFT layer, a rear polarizer, and a light source layer. The color filter typically has 30-50% ‘black matrix’ area that overlaps the data bus lines and TFTs on the TFT substrate and absorbs both the ambient light and backlight. According to one embodiment of the present invention, the black matrix on the color filter substrate is replaced by solar cells. In another embodiment of the present invention, the solar cell is fabricated on the TFT substrate overlapping data bus lines and TFTs regions. Yet in another embodiment of the present invention, the solar cell is fabricated on a separated substrate and is placed on top of the polarizer and absorbs unpolarized ambient light.

According to a specific embodiment of the present invention, a lens array substrate is coupled between the light source layer and the TFT substrate. A micro lens collects the backlight within a pixel cell and focuses the light with the focal point or the beam waist at the solar cell layer. As a result, a larger solar cell area is applied to absorb more ambient light while maintaining high fill ratio of the LCD pixels.

According to another specific embodiment of the present invention, the solar cell material is selected from at least silicon, a single crystal silicon, poly-crystalline silicon, amorphous silicon, gallium arsenide, cadmium telluride, copper indium diselenide, organic/inorganic, or hybrid cells. The substrate material is selected from glass, metal, plastic or polymer.

### BRIEF DESCRIPTION OF THE DRAWINGS

FIG. 1 is a simplified cross section diagram illustrating components of integrated solar cell on color filter of a LCD panel according to one embodiment of the present invention.

FIG. 2 is a simplified cross section diagram illustrating components of integrated solar cell on TFT substrate of a LCD panel according to one embodiment of the present invention.

FIG. 3 is a simplified cross section diagram illustrating components of integrated solar cell panel on top of polarizer panel of a LCD panel according to one embodiment of the present invention.

FIG. 4 is a simplified cross section diagram illustrating components of integrated solar cell LCD panel with micro lens according to one embodiment of the present invention.

### DETAILED DESCRIPTION OF THE INVENTION

According to the present invention, techniques for manufacturing objects are provided. More particularly, the invention provides a method and device for fabricating an out-of-plane compliant micro actuator. The method and device can be applied to LCD panels as well as other devices, for example, sensors, detectors, and optical systems.

As illustrated in Prior Art diagrams, a conventional LCD panel has a black matrix on the color filter substrate covers data bus-line and TFT (not shown) regions and blocks both ambient light and backlight from reflecting back to outside. As a result, aperture ratio ranges from 50% to 70% for typical LCD panels. The remaining 30% to 50% panel area is covered by the black matrix.

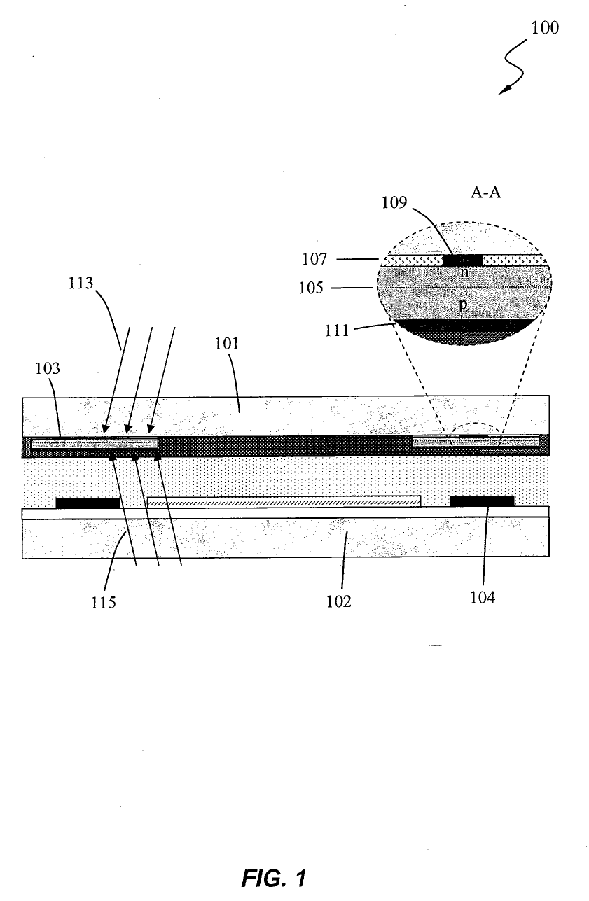

FIG. 1 is a simplified cross section diagram illustrating components of integrated solar cell LCD panel according to one embodiment of the present invention. As illustrated, the black matrix on the color filter substrate 101 is replaced by solar cells 103. The solar cell covers the data bus line 104 on a TFT substrate 102. As depicted in A-A zoomed-in view, the solar cell is consisted with a p-n junction 105, an AR coating, front contact 109 and back contact 111. The solar cell absorbs light from both the ambient light 113 and backlight 115. The absorbed light is converted into electricity that charges a battery.

In one embodiment of the present invention, the solar cell is fabricated directly on the color filter glass substrate using amorphous silicon and metallization similar to a TFT process. In another embodiment of the present invention, the solar cell is fabricated directly on the color filter glass substrate using polysilicon and metallization similar to a TFT process.

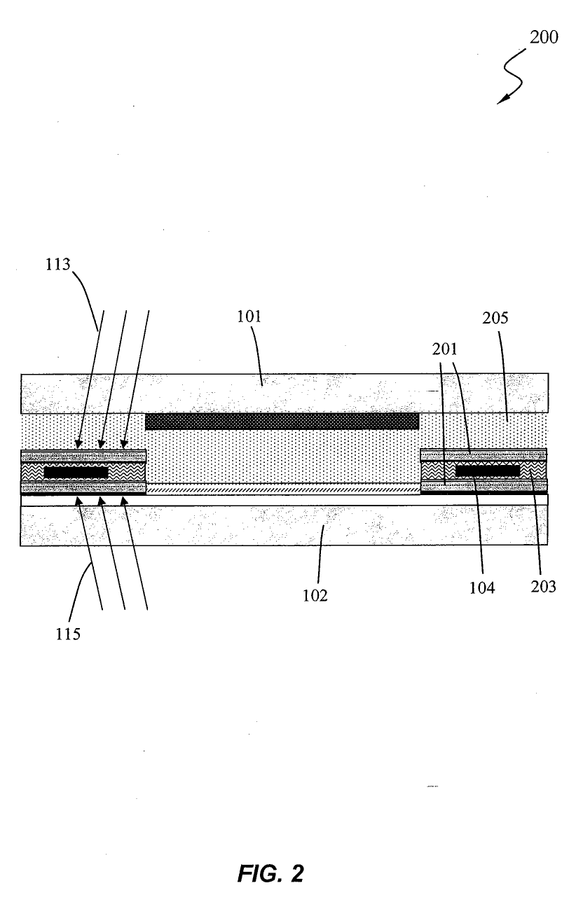

FIG. 2 is a simplified cross section diagram illustrating components of integrated solar cell LCD panel according to one embodiment of the present invention. As illustrated, solar cells 201 are fabricated on top as well as bottom of the data bus lines and TFTs (not shown). One fabrication method involves with using polysilicon and metallization similar to a TFT process. Dielectric layers 203 electrically isolates the solar cells from the data bus lines and TFTs. Similarly, a clear window region 205 is patterned on the color filter substrate above the solar cells, to allow maximum ambient light shedding on the top solar cells. The bottom solar cells absorb the backlight 115.

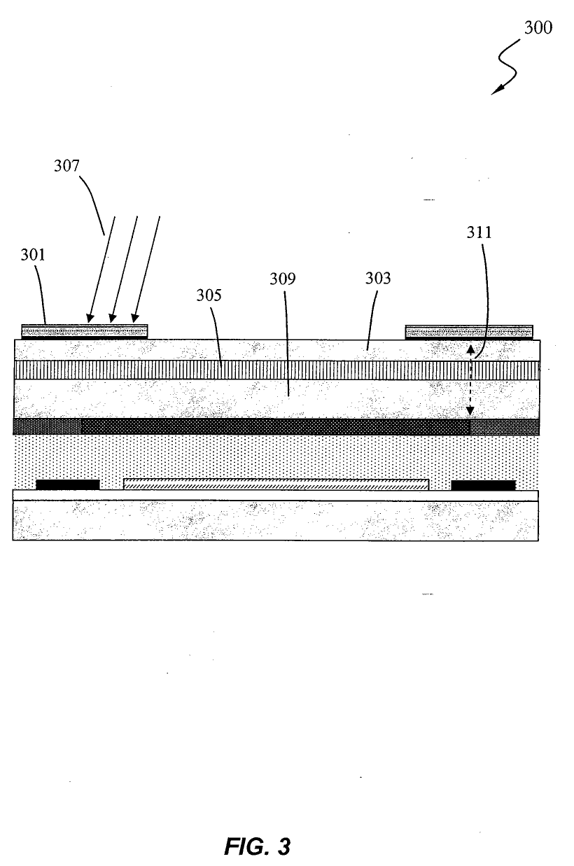

FIG. 3 is a simplified cross section diagram illustrating components of integrated solar cell LCD panel according to one embodiment of the present invention. As illustrated, solar cells 301 are fabricated on a separated substrate 303. The solar cell substrate is placed on top of the polarizer 305 and absorbs unpolarized ambient light 307. The solar cells on the solar cell substrate are patterned to match the black matrix region on the color filter substrate 309. The two substrates are aligned to each other 311.

According to one embodiment of the present invention, the solar cell is fabricated directly on the glass substrate using amorphous or polycrystalline silicon and metallization similar to a TFT process. In another specific embodiment of the present invention, thin film solar cells such as CIGS (a compound of Copper, Indium, Gallium and Selenium), CIS (a compound of Copper Indium Diselenide) are fabricated on substrate materials such as glass, plastic or polymer.

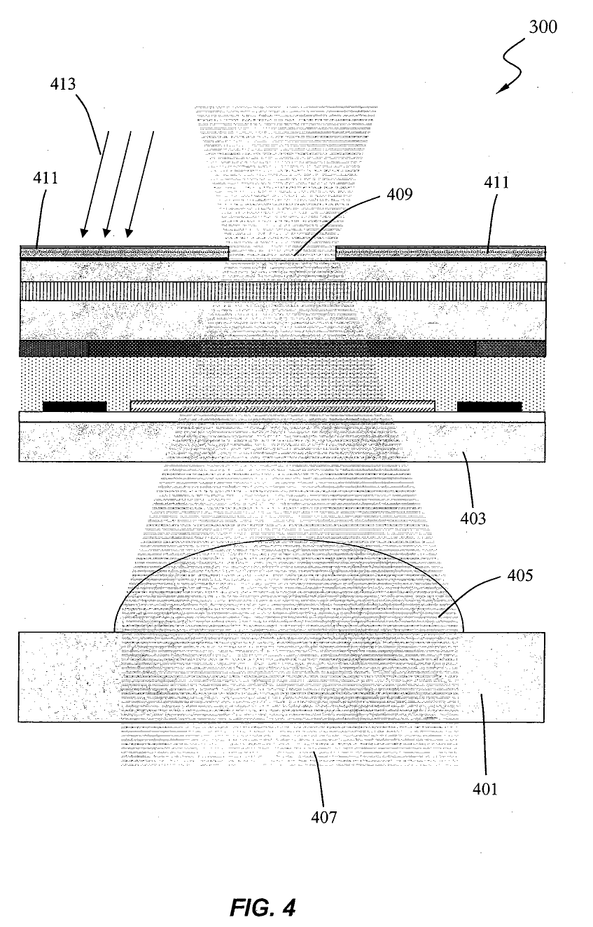

FIG. 4 is a simplified cross section diagram illustrating components of integrated solar cell LCD panel with micro lens according to one embodiment of the present invention. As illustrated, a lens array substrate 401 is placed between the TFT substrate 403. A micro lens 405 collects the backlight 407 within a pixel cell and focuses the light with the focal point or the beam waist 409 at the solar cell layer. As a result, a larger solar cell 411 can be placed to absorb more ambient light 413 without sacrificing the fill ratio of the LCD pixels.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An integrated display device including one or more solar cell regions, the device comprising:
a substrate comprising a surface region;
a plurality of pixel electrodes spatially disposed overlying the surface region;
a second substrate member overlying the surface region;
one or more photovoltaic regions provided on the second substrate.

2. The device of claim 1 wherein the second substrate further comprises one or more color filter regions.

3. The device of claim 1 wherein the substrate comprises a glass member.

4. The device of claim 1 further comprising a liquid crystal material overlying the plurality of pixel electrodes.

5. The device of claim 1 wherein the one or more photovoltaic regions is coupled to a first bus bar and a second bus bar.

6. The device of claim 1 wherein the one or more photovoltaic regions comprises a surface region, the surface region being capable to capturing electromagnetic radiation from an ambient source.

7. The device of claim 6 wherein the one or more photovoltaic regions comprises a backside surface region, the backside surface region capable of capturing electromagnetic radiation from a back light source, the backside region being coupled to the surface region via a common interface region.

8. The device of claim 1 wherein the one or more photovoltaic region comprises a p-type region coupled to an n-type region.

9. The device of claim 1 wherein the one or more photovoltaic regions is free from an overlying polarizing film.

10. The device of claim 1 wherein the second substrate comprises a third substrate and a fourth substrate, the one or more photovoltaic regions being provided on the third substrate.

11. An integrated display device including one or more solar cell regions, the device comprising:
a substrate comprising a surface region;
a plurality of thin film transistors spatially disposed overlying the surface region;
a plurality of pixel electrodes spatially disposed overlying the surface region;
a second substrate member overlying the surface region; and
one or more photovoltaic regions overlying the surface region.

12. The device of claim 2 wherein the one or more photovoltaic regions is overlying the plurality of thin film transistors.

13. The device of claim 2 wherein the one or more photovoltaic regions is underlying the plurality of thin film transistors.

14. The device of claim 2 further comprising one or more second photovoltaic regions underlying the plurality of thin film transistors.

15. The device of claim 2 wherein the one or more photovoltaic regions is provided in a semiconductor material.

16. The device of claim 2 wherein the semiconductor material is selected from at least silicon, a single crystal silicon, poly-crystalline silicon, amorphous silicon, gallium arsenide, cadmium telluride, copper indium diselenide, organic/inorganic, or hybrid cells.

17. The device of claim 2 wherein the one or more photovoltaic regions is provided using a thin film process.

18. The device of claim 2 wherein the thin film process uses a laser crystallization process.

19. The device of claim 2 wherein the one or more photovoltaic regions is provided from a bulk material.

20. The device of claim 2 one or more micro lenses coupled respectively to the plurality of pixel electrodes.

21. The device of claim 20 wherein the one or more micro lenses coupled respectively to the plurality of pixel electrodes are provided between a back light source and the plurality of pixel electrodes.

22. The device of claim 21 wherein the one or more micro lenses is characterized by a focal point at about a vicinity of a liquid crystal material, the liquid crystal material being coupled to the plurality of pixel electrodes.

23. The device of claim 22 wherein the one or more photovoltaic regions is characterized by a total photovoltaic area, the total photovoltaic area being equal to a total panel area less a total exposed pixel area, the total exposed pixel area of the plurality of pixel electrodes being less than 65% of a total area of the plurality of pixel electrodes.
